(19) United States
(12) Patent Application Publication
(10) Pub. No.: US 2025/0367682 A1
(43) Pub. Date: Dec. 4, 2025

(54) Pressure intensifier for vortex tube

(71) Applicant: Donald Lee Adle, Clearwater, FL (US)

(72) Inventor: Donald Lee Adle, Clearwater, FL (US)

(73) Assignee: Donald Lee Adle, Cleawater, FL (US)

(21) Appl. No.: 18/831,060

(22) Filed: May 28, 2024

(51) Int. Cl. B04C 3/06; B04C 3/00

(52) U.S. Cl. CPC B04C 3/06; B04C 2003/006

(57) ABSTRACT

Apparatus: Increased fluid pressure for a vortex tube.

### CROSS-REFERENCE TO RELATED APPLICATIONS

COMPRESSOR EFECTOR-VORTEX TUBE

### STATEMENT REGARDING FEDERALLY SPONSORED RESEARCH OR DEVELOPMENT

“Not Applicable” here (for reference only See MPEP 310)

### THE NAMES OF THE PARTIES TO A JOINT RESEARCH AGREEMENT

“Not Applicable” here (for reference only See 37 CFR 1.71(g))

### INCORPORATION-BY-REFERENCE OF MATERIAL SUBMITTED ON A READ-ONLY OPTICAL DISC, AS A TEXT FILE OR AN XML FILE VIAA PATENTELECTRONIC SYSTEM

“Not Applicable” here (for reference only—The specification is required to include an incorporation by reference of electronic documents that are to become part of the permanent US Patent and Trademark Office records in the file of a patent application. See statutes in instructions and also the “Legal Framework of Patent Electronic Systems” posted on the website.)

08.01 (c) Background of the Invention [R-07.2022]

### THE BACKGROUND OF THE INVENTION

may (but is not required to) include the following parts:

### (1) Field of the Invention

A statement of the field of art to which the invention pertains. This statement may include a paraphrasing of the applicable Cooperative Patent Classification (CPC) definitions. The statement should be directed to the subject matter of the claimed invention.

(2) Description of the Related Art

including information disclosed under 37 CFR 1.97 and 37 CFR 1.98: A paragraph(s) describing to the extent practical the state of the prior art or other information disclosed known to the applicant, including references to specific prior art or other information where appropriate. Where applicable, the problems involved in the prior art or other information disclosed which are solved by the applicant's invention should be indicated. See also MPEP § 608.01 (a), § 608.01 (p) and § 707.05 (b).

(i) Typical applications place special emphasis on how ejectors can be utilized to improve performance: heat/air-conditioning, heat, or refrigeration systems. Nowadays, such cycles harness solar heat or other low-grade heat sources. The patent by Gay (1931) described how a two-phase ejector used to improve the performance of refrigeration systems by reducing the inherent throttling losses of the expansion valve.

### STATEMENT REGARDING PRIOR DISCLOSURES BY THE INVENTOR OR JOINT INVENTOR

### ABANDONMENT: COMPRESSOR EFECTOR-VORTEX TUBE

### APPLICATION NUMBER: 16501129

Confirmation number: 4023

### Fiing Date: Jan. 14, 2020

### Name Inventor: Donald Lee Adle

### Art Unit 3745

### BACKGROUND OF THE INVENTION

(Content instructions—the background should be set forth in 2 parts (as below) (See MPEP 608.01 (c))

### Field of the Invention

Invention relates to ejector compressors application to environmentally beneficial energy efficient technologies in vortex tubes. Meeting all requirements by any regulatory body and in accordance with any that impacting the HVAC industry.

### Description of Related Art

“Not applicable” here (instructions-a description of the related art including information disclosed under 37 CFR 1.97and 37 CFR 1.98: A description of the related art known to the applicant and including, if applicable, references to specific related art and problems involved in the prior art which are solved by the applicant's invention. This item may also be titled “Background Art”)

### BRIEF SUMMARY OF INVENTION

Put summary here or say “Not applicable” here (instructions—See MPEP 608.01 (d)—A brief summary or general statement of the invention as set forth in 37 CFR 1.73. The summary is separate and distinct from the abstract and is directed toward the invention rather than the disclosure as a whole. The summary may point out the advantages of the invention or how it solves problems previously existent in the prior art (and preferably indicated in the Background of the Invention). In chemical cases it should point out in general terms the utility of the invention. If possible, the nature and gist of the invention or the inventive concept should be set forth. Objects of the invention should be treated briefly and only to the extent that they contribute to the understanding of the invention.

Typical applications place special emphasis on how ejectors can be utilized to improve performance: heat/air-conditioning, heat, or refrigeration systems. Nowadays, such cycles harness solar heat or other low-grade heat sources. The patent by Gay (1931) described how a two-phase ejector used to improve the performance of refrigeration systems by reducing the inherent throttling losses of the expansion valve.

### BRIEF DESCRIPTION OF THE VIEW OF THE DRAWING(S)

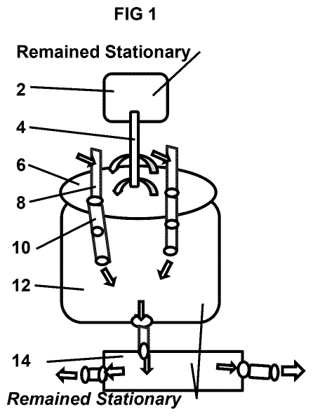

The objects, features and other advantages of the present apparatus will be more clearly understood from accompanying drawing FIG. 1. remained stationary motor 2, motor rotation axis 4, convergent surrounding cover 6, convergent-divergent cover blade 8, convergent-divergent pinched in middle nozzle 10, remained stationary convergent-divergent pinched in middle nozzle tube 12, remained stationary vortex tube.

### DETAILED DESCRIPTION OF THE INVENTION

A preferred embodiment of the apparatus comprising: In possession of remained stationary motor 2 to in possession of motor rotation axis 4, in possession of motor rotation axis 4 joined be in possession of convergent surrounding cover 6, in possession of convergent surrounding cover 6 joined to in possession of close together of convergent of remained stationary convergent-divergent pinched in middle nozzle tube 12, in possession convergent surrounding cover 6 to in possession of convergent-divergent cover blade 8, in possession convergent-divergent cover blade 8 to in of possession of fluid conduit only inlet and not closed possession of fluid conduit only outlet and not closed, in possession convergent-divergent cover blade 8 to in possession of fluid conduit only outlet and not closed joined to in possession of convergent-divergent pinched in the middle cover nozzle 10 to in possession of fluid conduit only inlet and not closed, in possession convergent-divergent pinched in the middle cover nozzle 10 to in possession of fluid conduit only inlet and not closed possession of fluid conduit only outlet and not closed to be within convergent interior of remained stationary convergent-divergent pinched in middle nozzle tube 12, in possession remained stationary convergent-divergent pinched in middle nozzle tube 12 to in possession of fluid conduit only outlet and not closed, in possession convergent of remained stationary convergent-divergent pinched in middle nozzle tube 12 to in possession of joined to in remained stationary vortex tube 14, in possession convergent of remained stationary convergent-divergent pinched in middle nozzle tube 12 to in possession of fluid conduit only outlet and not closed joined to in remained stationary vortex tube 14 to in possession of fluid conduit only inlet and not closed, in possession remained stationary vortex tube 14 to in possession of generates cold streams fluid conduit only outlet and not closed with stationary vortex tube 14 to in possession of generates hot streams fluid conduit outlet and not closed, in possession first convergent surrounding cover 6 suitable for at least one or two or more of with each one to in possession first convergent surrounding cover 6 to in possession of first convergent-divergent cover blade 8, in possession convergent-divergent cover blade 8 to in of possession of fluid conduit only inlet and not closed possession of fluid conduit only outlet and not closed, in possession convergent-divergent cover blade 8 to in possession of fluid conduit only outlet and not closed joined to in possession of convergent-divergent pinched in the middle cover nozzle 10 to in possession of fluid conduit only inlet and not closed, in possession convergent-divergent pinched in the middle cover nozzle 10 to in possession of fluid conduit only inlet and not closed possession of fluid conduit only outlet and not closed to be within convergent interior of remained stationary convergent-divergent pinched in middle nozzle tube 12.

### Claim or Claims (Commencing on a Separate Sheet)

Put Claim here (instructions—

See 37 CFR 1.75 and MPEP 608.01 (m).

The claim or claims must commence on a separate sheet or electronic page (37 CFR 1.52 (b) (3)). Where a claim sets forth a plurality of elements or steps, each element or step of the claim should be separated by a line indention. There may be plural indentations to further segregate sub combinations or related steps. See 37 CFR 1.75 and MPEP 608.01 (i)-(p).

### Abstract Of The Disclosure (Commencing ona Separate Sheet)

Put abstract here (instructions—See 37 CFR 1.72 (b) and MPEP 608.01 (b). The abstract is a brief narrative of the disclosure as a whole, as concise as the disclosure permits, in a single paragraph preferable not exceeding 150 words, commencing on a separate sheet following the claims.

### Sequence Listing

Put sequence listing here or say “Not Applicable” here (instructions—See 37 CFR 1.821-18.25 and MPEP 2421-2431. The required for a sequence listing applies to all sequences disclosed in a given application whether the sequences are claimed or not. See MPEP 2422.01).

### Specification Sections

Title of the Invention Pressure intensifier for vortex tube

### Cross-Reference to Related Applications

“Not Applicable” here (for reference only-See 37 CFR 1.78 and MPEP 211 et seq.)

### Statement Regarding Federally Sponsored Research or Development

“Not Applicable” here (for reference only See MPEP 310)

### The Names of the Parties to a Joint Research Agreement

“Not Applicable” here (for reference only See 37 CFR 1.71 (g))

### Incorporation-By-Reference of Material Submitted on a Read-Only Optical Disc, as a Text File or an Xml File Viaa Patentelectronic System

“Not Applicable” here (for reference only-The specification is required to include an incorporation by reference of electronic documents that are to become part of the permanent US Patent and Trademark Office records in the file of a patent application. See statutes in instructions and also the “Legal Framework of Patent Electronic Systems” posted on the website.)

### 608.01 (c) Background of the Invention [R-07.2022]

The Background of the Invention may (but is not required to) include the following parts:

### (1) Field of the Invention

A statement of the field of art to which the invention pertains. This statement may Include a paraphrasing of the applicable Cooperative Patent Classification (CPC) definitions. The statement should be directed to the subject matter of the claimed invention.

### (2) Description of the Related Art Including Information Disclosed Under 37 CFR 1.97 and 37 CFR 1.98

A paragraph(s) describing to the extent practical the state of the prior art or other information disclosed known to the applicant, including references to specific prior art or other information where appropriate. Where applicable, the problems involved in the prior art or other information disclosed which are solved by the applicant's invention should be indicated. See also MPEP § 608.01(a), § 608.01(p) and § 707.05(b).

Typical applications place special emphasis on how ejectors can be utilized to improve performance: heat/air-conditioning, heat, or refrigeration systems. Nowadays, such cycles harness solar heat or other low-grade heat sources. The patent by Gay (1931) described how a two-phase ejector used to improve the performance of refrigeration systems by reducing the inherent throttling losses of the expansion valve.

### Statement Regarding Prior Disclosures by the Inventor or Joint Inventor

### Abandonment

### Background Of The Invention

(Content instructions—the background should be set forth in 2 parts (as below) (See MPEP 608.01 (c))

### Field of the Invention

Invention relates to ejector compressors application to environmentally beneficial energy efficient technologies in vortex tubes. Meeting all requirements by any regulatory body and in accordance with any that impacting the HVAC industry.

### Description of Related Art

“Not applicable” here (instructions—a description of the related art including information disclosed under 37 CFR 1.97 and 37 CFR 1.98: A description of the related art known to the applicant and including, if applicable, references to specific related art and problems involved in the prior art which are solved by the applicant's invention. This item may also be titled “Background Art”)

### Brief Summary Of Invention

Put summary here or say “Not applicable” here (instructions—See MPEP 608.01 (d)—A brief summary or general statement of the invention as set forth in 37 CFR 1.73. The summary is separate and distinct from the abstract and is directed toward the invention rather than the disclosure as a whole. The summary may point out the advantages of the invention or how it solves problems previously existent in the prior art (and preferably indicated in the Background of the Invention). In chemical cases it should point out in general terms the utility of the invention. If possible, the nature and gist of the invention or the inventive concept should be set forth. Objects of the invention should be treated briefly and only to the extent that they contribute to the understanding of the invention.

Typical applications place special emphasis on how ejectors can be utilized to improve performance: heat/air-conditioning, heat, or refrigeration systems. Nowadays, such cycles harness solar heat or other low-grade heat sources. The patent by Gay (1931) described how a two-phase ejector used to improve the performance of refrigeration systems by reducing the inherent throttling losses of the expansion valve.

### Brief Description of the Several Views of the Drawing(s)

Put brief description here or say “Not applicable” here (instruction—See MPEP 608.01 (f)—A reference to and brief description of the drawing(s) as set forth in 37 CFR 1.74.)

### Brief Description of the View of the Drawing

The objects, features and other advantages of the present apparatus will be more clearly understood from accompanying drawing FIG. 1. remained stationary motor 2, motor rotation axis 4, convergent surrounding cover 6, convergent-divergent cover blade 8, convergent-divergent pinched in middle nozzle 10, remained stationary convergent-divergent pinched in middle nozzle tube 12, remained stationary vortex tube

### Detailed Description of the Invention

Put detailed description here or say “Not Applicable” here (instructions-See MPEP 608.01 (g). A description of the preferred embodiment(s) of the invention as required in 37 CFR 1.71. The description should be short and specific as necessary to describe the invention adequately and accurately. Where elements or groups of elements, compounds, and processes, which are conventional and generally widely known in the field of the invention described, and their exact nature or type is not necessary for an understanding and use of the invention by a person skilled in the art, they should not be described in detail. However, where particularly complicated subject matter is involved or where the elements, compounds, or processes may not be commonly or widely known in the field, the specifications should refer to another patent or readily available publication which adequately describes the subject matter.)

A preferred embodiment of the apparatus comprising: In possession remained stationary motor 2 to in possession of motor rotation axis 4, in motor rotation axis 4 joined to in possession of convergent surrounding cover 6, in possession convergent surrounding cover 6 joined to in possession of close together of convergent of remained stationary convergent-divergent pinched in middle nozzle tube 12, in possession convergent surrounding cover 6 to in possession of convergent-divergent cover blade 8.

in possession convergent-divergent cover blade 8 to in of possession of fluid conduit only inlet and not closed possession of fluid conduit only outlet and not closed, in possession convergent-divergent cover blade 8 to in possession of fluid conduit only outlet and not closed joined to in possession of convergent-divergent pinched in the middle cover nozzle 10 to in possession of fluid conduit only inlet and not closed, in possession convergent-divergent pinched in the middle cover nozzle 10 to in possession of fluid conduit only inlet and not closed possession of fluid conduit only outlet and not closed to be within convergent interior of remained stationary convergent-divergent pinched in middle nozzle tube 12, in possession remained stationary convergent-divergent pinched in middle nozzle tube 12 to in possession of fluid conduit only outlet and not closed, in possession convergent of remained stationary convergent-divergent pinched in middle nozzle tube 12 to be in possession of joined to in remained stationary vortex tube 14, in possession convergent of remained stationary convergent-divergent pinched in middle nozzle tube 12 be in possession of fluid conduit only outlet and not closed joined to in remained stationary vortex tube 14 to in possession of fluid conduit only inlet and not closed, in possession remained stationary vortex tube 14 to in possession of generates cold streams fluid conduit only outlet and not closed with stationary vortex tube 14 to in possession of generates hot streams fluid conduit outlet and not closed, in possession first convergent surrounding cover 6 suitable for at least one or two or more of with each one to in possession first convergent surrounding cover 6 to in possession of first convergent-divergent cover blade 8, in possession convergent-divergent cover blade 8 to in of possession of fluid conduit only inlet and not closed possession of fluid conduit only outlet and not closed, in possession convergent-divergent cover blade 8 to in possession of fluid conduit only outlet and not closed joined to in possession of convergent-divergent pinched in the middle cover nozzle 10 to in possession of fluid conduit only inlet and not closed, in possession convergent-divergent pinched in the middle cover nozzle 10 to in possession of fluid conduit only inlet and not closed possession of fluid conduit only outlet and not closed to be within convergent interior of remained stationary convergent-divergent pinched in middle nozzle tube 12.

### Claim or Claims (Commencing on a Separate Sheet)

Put Claim here (instructions—See 37 CFR 1.75 and MPEP 608.01 (m). The claim or claims must commence on a separate sheet or electronic page (37 CFR 1.52(b) (3)). Where a claim sets forth a plurality of elements or steps, each element or step of the claim should be separated by a line indention. There may be plural indentations to further segregate sub combinations or related steps. See 37 CFR 1.75 and MPEP 608.01 (i)-(p).

### Abstract of the Disclosure (Commencing on a Separate Sheet)

Put abstract here (instructions-See 37 CFR 1.72 (b) and MPEP 608.01 (b). The abstract is a brief narrative of the disclosure as a whole, as concise as the disclosure permits, in a single paragraph preferable not exceeding 150 words, commencing on a separate sheet following the claims.

Sequence Listing

Put sequence listing here or say “Not Applicable” here (instructions—See 37CFR 1.821-18.25 and MPEP 2421-2431. The required for a sequence listing applies to all sequences disclosed in a given application whether the sequences are claimed or not. See MPEP 2422.01).

What is claimed:

1-5. (cancled)

6. A preferred embodiment of apparatus comprising: In possession of remained stationary motor (2) to in possession of motor rotation axis (4), in possession of motor rotation axis (4) joined to in possession of convergent surrounding cover (6), in possession of convergent surrounding cover (6) joined to in possession of close together of convergent of remained stationary convergent-divergent pinched in middle nozzle tube (12).

7. A preferred embodiment of apparatus comprising: In possession convergent surrounding cover (6) to in possession of convergent-divergent cover blade (8), in possession convergent-divergent cover blade (8) to in possession of fluid conduit only inlet and not closed possession of fluid conduit only outlet and not closed.

8. A preferred embodiment of apparatus comprising: In possession convergent-divergent cover blade (8) to in possession of fluid conduit only outlet and not closed joined to in possession of convergent-divergent pinched in the middle cover nozzle (10) to in possession of fluid conduit only inlet and not closed.

9. A preferred embodiment of apparatus comprising: In possession convergent-divergent pinched in the middle cover nozzle (10) to in possession of fluid conduit only inlet and not closed possession of fluid conduit only outlet and not closed to within convergent interior of remained stationary convergent-divergent pinched in middle nozzle tube (12).

10. A preferred embodiment of apparatus comprising: In possession remained stationary convergent-divergent pinched in middle nozzle tube (12) to in possession of fluid conduit only outlet and not closed, in possession convergent of remained stationary convergent-divergent pinched in middle nozzle tube (12) to in possession of joined to in remained stationary vortex tube (14).

12. A preferred embodiment of apparatus comprising: In possession convergent of remained stationary convergent-divergent pinched in middle nozzle tube (12) to in possession of fluid conduit only outlet and not closed joined to in remained stationary vortex tube (14) to in possession of fluid conduit only inlet and not closed, in possession remained stationary vortex tube (14) to in possession of generates cold streams fluid conduit only outlet and not closed with stationary vortex tube (14) to in possession of generates hot streams fluid conduit outlet and not closed.

13. A preferred embodiment of apparatus comprising: In possession first convergent surrounding cover (6) suitable for at least one or two or more of with each one to in possession first convergent surrounding cover (6) to in possession of first convergent-divergent cover blade (8), in possession convergent-divergent cover blade (8) to in possession of fluid conduit only inlet and not closed possession of fluid conduit only outlet and not closed, in possession convergent-divergent cover blade (8) to in possession of fluid conduit only outlet and not closed joined to in possession of convergent-divergent pinched in the middle cover nozzle (10) to in possession of fluid conduit only inlet and not closed, in possession convergent-divergent pinched in the middle cover nozzle (10) to in possession of) fluid conduit only inlet and not closed possession of fluid conduit only outlet and not closed to within convergent interior of remained stationary convergent-divergent pinched in middle nozzle tube (12).
